(19) United States
(12) Patent Application Publication
(10) Pub. No.: US 2025/0227368 A1
(43) Pub. Date: Jul. 10, 2025

(54) ELECTRONIC DEVICE COMPRISING CAMERA MODULE AND OPERATING METHOD THEREFOR

(71) Applicant: Samsung Electronics Co., Ltd., Suwon-si (KR)

(72) Inventors: Wonseok SONG, Suwon-si (KR); Kyungdong YANG, Suwon-si (KR); Jaemu YUN, Suwon-si (KR); Jiyeon JO, Suwon-si (KR); Songha CHOI, Suwon-si (KR)

(21) Appl. No.: 19/094,060

(22) Filed: Mar. 28, 2025

Related U.S. Application Data
(63) Continuation of application No. PCT/KR2023/014646, filed on Sep. 25, 2023.

(30) Foreign Application Priority Data
Sep. 29, 2022 (KR) 10-2022-0124765
Dec. 8, 2022 (KR) 10-2022-0170350

(51) Int. Cl. H04N 23/68

(52) U.S. Cl. CPC H04N 23/683; H04N 23/6812

(57) ABSTRACT

An electronic device is provided. The electronic device includes a motion sensor configured to output a signal for acquiring motion data corresponding to motion of the electronic device, a camera module including an image sensor and an optical image stabilization (OIS) module which is configured to perform OIS based on the motion of the electronic device, memory storing one or more computer programs, and one or more processors communicatively coupled to the motion sensor, the camera module, and the memory, wherein the one or more computer programs include computer-executable instructions that, when executed by the one or more processors individually or collectively, cause the electronic device to determine motion state information based on a size of the motion data when the exposure time of the image sensor is less than or equal to a pre-defined exposure time while image frames are constantly acquired through the camera module, determine a suppression ratio related to an actuation range of the OIS module, based on the motion state information, and control an operation of the OIS module based on the determined suppression ratio.

### CROSS-REFERENCE TO RELATED APPLICATION(S)

This application is a continuation application, claiming priority under 35 U.S.C. § 365 (c), of an International application No. PCT/KR2023/014646, filed on Sep. 25, 2023, which is based on and claims the benefit of a Korean patent application number 10-2022-0124765, filed on Sep. 29, 2022, in the Korean Intellectual Property Office, and of a Korean patent application number 10-2022-0170350, filed on Dec. 8, 2022, in the Korean Intellectual Property Office, the disclosure of each of which is incorporated by reference herein in its entirety.

### BACKGROUND

### 1. Field

The disclosure relates to an electronic device including a camera module and a control method thereof.

### 2. Description of Related Art

As the photographing function of mobile devices is enhanced recently, the technology for correcting on taking photos or videos by using mobile devices is developing.

For example, mobile devices are provided with functions of optical image stabilization (OIS) and video digital image stabilization (VDIS) to be able to obtain enhanced photos or videos.

Here, OIS is a method for reducing shaking by shifting a lens assembly or an image sensor included in a camera module, and VDIS is a method for reducing shaking through digital processing in mobile devices.

The above information is presented as background information only to assist with an understanding of the disclosure. No determination has been made, and no assertion is made, as to whether any of the above might be applicable as prior art with regard to the disclosure.

### SUMMARY

An electronic device may solve defects caused by shaking during video recording through the OIS function. However, the moving range of a lens assembly or an image sensor for the OIS function is limited. For example, the maximum value of a physical correction angle for performing the OIS function is 1 degree. In this case, the electronic device may not cover large motions of the electronic device due to the limitation on the correction angle.

To solve the above-described limitations, the electronic device may improve jitter by adaptively adjusting a suppression ratio according to a relative position of the lens assembly or the image sensor.

The electronic device may solve the problem on the jitter to some extent by adaptively adjusting the suppression ratio. However, the electronic device may have difficulty in applying the suppression ration rapidly every moment, which leads to a problem of micro-shaking.

In this case, the electronic device may extend the maximum value of the physical correction angle for performing the OIS function, but may have problems caused by the extension of the correction angle.

Aspects of the disclosure are to address at least the above-mentioned problems and/or disadvantages and to provide at least the advantages described below. Accordingly, an aspect of the disclosure is to provide an electronic device including a camera module and a control method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a motion sensor configured to output a signal for acquiring motion data corresponding to a motion of the electronic device, a camera module including an image sensor and an optical image stabilization (OIS) module which is configured to perform OIS based on the motion of the electronic device, memory storing one or more computer programs, and one or more processors communicatively coupled to the motion sensor, the camera module, and the memory, wherein the at least one processor one or more computer programs include computer-executable instructions that, when executed by the one or more processors individually or collectively, cause the electronic device to determine motion state information based on a size of the motion data when an exposure time of the image sensor is less than or equal to a pre-defined exposure time while image frames are constantly acquired through the camera module, determine a suppression ratio related to an actuation range of the OIS module, based on the motion state information, and control an operation of the OIS module based on the determined suppression ratio.

According to an embodiment of the disclosure, the motion state information includes a motion level based on which the size of the motion data is divided stepwise, the memory stores a table in which suppression ratios are assigned by motion levels, and the at least one processor determine a suppression ratio on the OIS module based on the stored table.

According to an embodiment of the disclosure, the at least one processor adaptively adjust the suppression ratio based on a correction angle position of the OIS module when the exposure time is longer than the pre-defined exposure time.

According to an embodiment of the disclosure, the at least one processor adaptively adjust the suppression ratio based on a correction angle position of the OIS module when the exposure time is less than or equal to the pre-defined exposure time and the motion level is greater than or equal to a pre-defined value.

According to an embodiment of the disclosure, the at least one processor adaptively adjust the suppression ratio based on a required amount of correction angle for the OIS module when the exposure time is less than or equal to the pre-defined exposure time and the motion level is greater than or equal to a pre-defined value.

According to an embodiment of the disclosure, the camera module have the actuation range of the OIS module extended from a first range to a second range.

According to an embodiment of the disclosure, the at least one processor acquire the motion level by processing the motion data, based on the actuation range of the OIS module which is extended from the first range to the second range.

According to an embodiment of the disclosure, the at least one processor control the OIS module, based on the suppression ratio which increases stepwise according to the motion level.

According to an embodiment of the disclosure, the motion sensor includes at least one of an acceleration sensor which outputs a signal for acquiring acceleration data or a gyro sensor which outputs a signal for acquiring angular velocity data, and the at least one processor determine a motion level corresponding to the motion of the electronic device, based on at least one of the acceleration data or the angular velocity data.

According to an embodiment of the disclosure, the electronic device further includes an illuminance sensor configured to output a signal for measuring ambient illuminance of the electronic device, and the at least one processor determine the exposure time based on the measured illuminance, and acquire the motion level by processing the motion data when the exposure time is less than or equal to the pre-defined exposure time.

In accordance with another aspect of the disclosure, an operating method of an electronic device is provided. The operating method includes constantly acquiring image frames through a camera module, acquiring motion data corresponding to a motion of the electronic device, determining motion state information based on a size of the motion data when an exposure time of an image sensor is less than or equal to a pre-defined exposure time while the image frames are constantly acquired, determining a suppression ratio related to an actuation range of an OIS module, based on the motion state information, and controlling an operation of the OIS module based on the determined suppression ratio.

According to an embodiment of the disclosure, determining the motion state information based on the size of the motion data includes determining a suppression ratio on the OIS module based on a table in which suppression ratios are assigned by motion levels, and the motion state information includes a motion level based on which the size of the motion data is divided stepwise.

According to an embodiment of the disclosure, the operating method further includes adaptively adjusting the suppression ratio based on a correction angle position of the OIS module when the exposure time is longer than the pre-defined exposure time.

According to an embodiment of the disclosure, the operating method further includes adaptively adjusting the suppression ratio based on a correction angle position of the OIS module when the exposure time is less than or equal to the pre-defined exposure time and the motion level is greater than or equal to a pre-defined value.

According to an embodiment of the disclosure, the operating method further includes adaptively adjusting the suppression ratio based on a required amount of correction angle on the OIS module when the exposure time is less than or equal to the pre-defined exposure time and the motion level is greater than or equal to the pre-defined value.

According to an embodiment of the disclosure, acquiring the motion level by processing the motion data includes, when the actuation range of the OIS module is extended from a first range to a second range, acquiring the motion level by processing the motion data.

In accordance with another aspect of the disclosure, an electronic device is provided. The electronic device includes a motion sensor configured to output a signal for acquiring motion data corresponding to a motion of the electronic device, a camera module including a lens module and configured to perform an OIS function, an OIS module configured to shift the lens module within an actuation range of the OIS function, memory storing one or more computer programs, and one or more processors communicatively coupled to the motion sensor, the camera module, the OIS module, and the memory, wherein the one or more computer programs include computer-executable instructions that, when executed by the one or more processors individually or collectively, cause the electronic device to control the OIS module to shift the lens module when a motion of the electronic device occurs while image frames are constantly acquired through the camera module, acquire a correction angle of the OIS function at a position to which the lens module is shifted, determine a transform angle for perspective transform of the image frame based on the correction angle, and perform video digital image stabilization (VDIS) based on the transform angle.

According to an embodiment of the disclosure, the OIS module shifts the lens module according to a second range of the actuation range of the OIS function which is larger than a first range.

According to an embodiment of the disclosure, the at least one processor acquire a correction angle at regular intervals while acquiring the image frame, and the correction angle includes a first correction angle and a second correction angle that is acquired after the first correction angle, and the at least one processor determine the transform angle based on an average between the first correction angle and the second correction angle.

According to an embodiment of the disclosure, the at least one processor perform lens distortion correction (LDC) before transforming the image frame based on the transform angle.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include constantly acquiring image frames through a camera module, acquiring motion data corresponding to a motion of the electronic device, determining motion state information based on a size of the motion data when an exposure time of an image sensor is less than or equal to a pre-defined exposure time while the image frames are constantly acquired, determining a suppression ratio related to an actuation range of an optical image stabilization (OIS) module, based on the motion state information, and controlling an operation of the OIS module based on the determined suppression ratio.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a camera module according to an embodiment of the disclosure;

FIG. 3 is a control block diagram of an electronic device including a camera module according to an embodiment of the disclosure;

FIG. 4 is a view illustrating an OIS actuation range in which a camera module performs OIS according to an embodiment of the disclosure;

FIG. 5 is a view illustrating an example of determining a suppression ratio by the camera module according to an embodiment of the disclosure;

FIG. 6 is a view illustrating an example of determining a suppression ratio by the camera module when a required amount of OIS correction exceeds the OID actuation range according to an embodiment of the disclosure;

FIG. 7 is a view illustrating an example of determining a suppression ratio when the OIS maximum actuation range of the camera module is extended according to an embodiment of the disclosure;

FIG. 8 is a flowchart of an operating method of the electronic device according to an embodiment of the disclosure;

FIG. 9 is a view illustrating a priority between jitter and micro-shaking with an exposure time according to an embodiment of the disclosure;

FIG. 10 is a view illustrating an example of determining a suppression ratio when the exposure time is relatively long according to an embodiment of the disclosure;

FIG. 11 is a view illustrating an example of determining a suppression ratio when the exposure time is relatively short according to an embodiment of the disclosure;

FIG. 12 is a view illustrating an OIS operation when there is no motion of the electronic device according to an embodiment of the disclosure;

FIG. 13 is a view illustrating a state in which the OIS function is turned off when there is a motion of the electronic device according to an embodiment of the disclosure;

FIG. 14 is a view illustrating a state in which the OIS function is turned on when there is a motion of the electronic device according to an embodiment of the disclosure;

FIG. 15 is a flowchart of an operating method of an electronic device according to an embodiment of the disclosure;

FIG. 16 is a view illustrating an example of perspective transform according to an embodiment of the disclosure; and

FIG. 17 is a view illustrating an example of a process of deriving an OIS angle for perspective transform in FIG. 16 according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

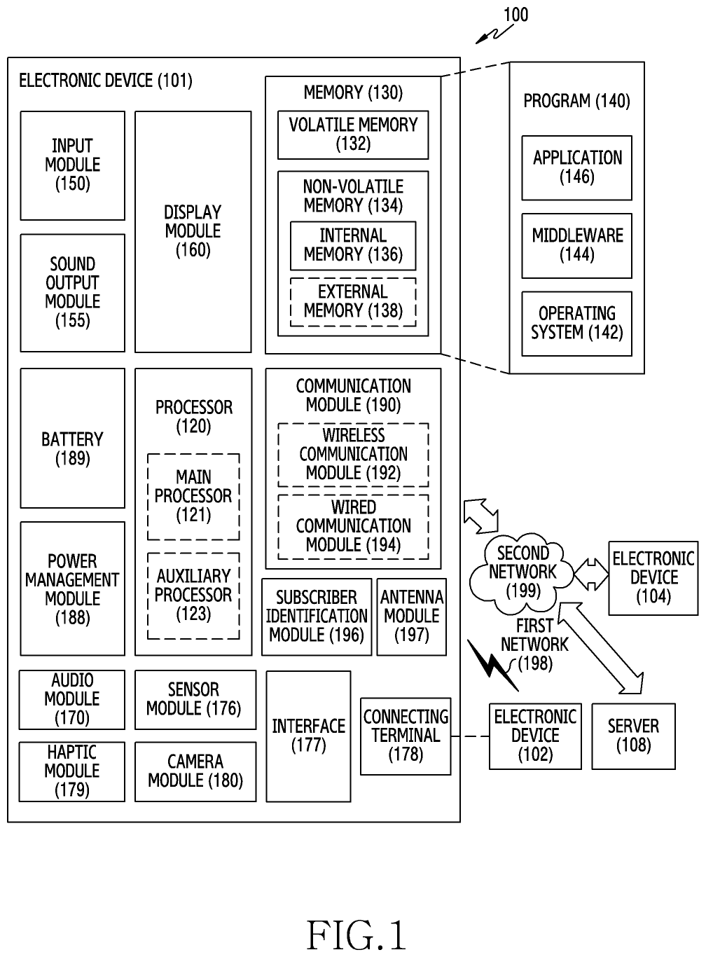

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

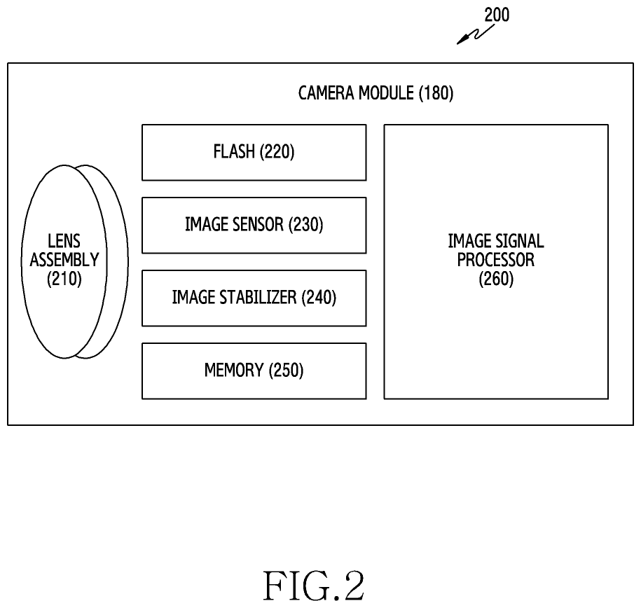

FIG. 2 is a block diagram 200 illustrating the camera module 180 according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130. The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

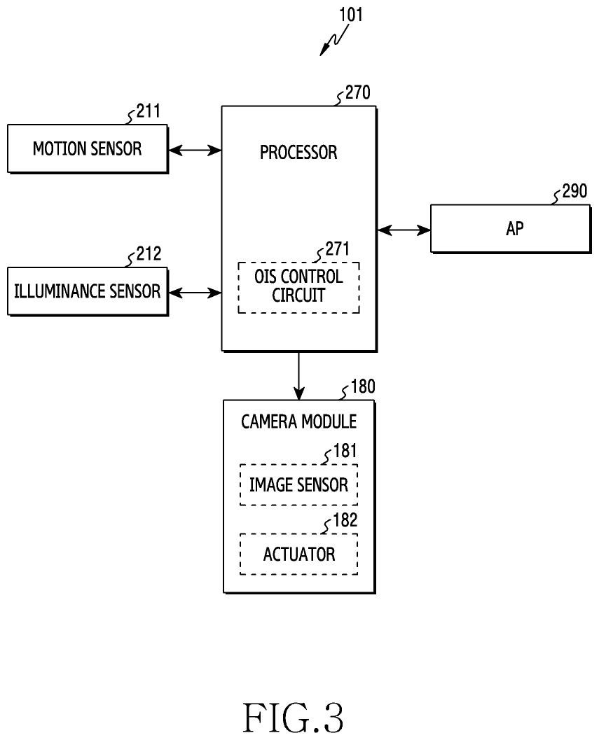

FIG. 3 is a control block diagram of an electronic device including a camera module according to an embodiment of the disclosure.

According to an embodiment, FIG. 3 illustrates schematic components included in the electronic device 101, and the electronic device 101 according to FIG. 3 may include the same or similar components as or to those of the electronic device 101 shown in FIG. 1.

Referring to FIG. 3, the electronic device 101 may include a motion sensor 211, an illuminance sensor 212, a processor 270, and a camera module 180.

According to an embodiment, the electronic device 101 may include the motion sensor 211. The processor 270 may detect a motion of the electronic device 101 via the motion sensor 211. The motion sensor 211 may provide motion data corresponding to a motion of the electronic device 101 to the processor 270.

According to an embodiment, the motion sensor 211 may provide motion data to the processor 270 to cause the processor 270 to process the motion data and to acquire a motion level. The motion level may be a criterion for motions of the electronic device 101 and may be used for determining a suppression ration in the OIS function, which will be described later. Motion data may be data related to a physical momentum of the electronic device 101, and may be acquired via a signal outputted from the motion sensor 211. Specifically, motion data may include at least one piece of data resulting from processing of signals generated in an acceleration sensor, a gyro sensor (gyroscope), a magnetic sensor or a hall sensor.

In an embodiment, the motion sensor 211 may include at least one of an acceleration sensor, a gyro sensor (gyroscope), a magnetic sensor, or a hall sensor. For example, the acceleration sensor may measure an acceleration that acts on three axes (for example, an X-axis, a Y-axis, or a Z-axis) of the electronic device 101. In another example, the gyro sensor may measure a rotation angle or a slope on the 3 axes (for example, the X-axis, the Y-axis or the Z-axis) of the electronic device 101. However, the above-mentioned sensors and the motion sensor 211 may further include at least one other type of sensor.

In an embodiment, the electronic device 101 may include the illuminance sensor 212. The processor 270 may measure ambient illuminance (or brightness) of the electronic device 101 via the illuminance sensor 212. In an embodiment, the processor 270 may determine whether the measured illuminance is less than a designated value, which corresponds to a low-illuminance environment. In an embodiment, the processor 270 may determine whether the measured illuminance is greater than or equal to the designated value, which corresponds to a high-illuminance environment.

According to an embodiment, it may be understood that the processor 270 includes at least one processor. In an embodiment, the processor 270 may include an OIS control circuit 271, and may exchange various data with an application processor (AP) 290. In an embodiment, the AP 290 may provide an exposure time, which is information set for the camera module 180, to the processor 270. As a similar concept, the AP 290 in an embodiment may provide a shutter speed, which is information set for the camera module 180, to the processor 270. In an embodiment, the processor 270 may further include at least one of an image signal processor 260 and a communication processor (CP).

According to an embodiment, the OIS control circuit 271 may control the camera module 180 to perform an OIS operation. For example, the OIS control circuit 271 may control the camera module 180 to perform the OIS function, based on motion data acquired from the motion sensor 211. In an embodiment, the OIS control circuit 271 may be disposed adjacent to the camera module 180. For example, the OIS control circuit 271 may be disposed on a certain surface of the inside of the camera module 180.

According to an embodiment, the OIS control circuit 271 may acquire acceleration data from the acceleration sensor. The OIS control circuit 271 may acquire information on a speed (acceleration) at which the electronic device shakes, by performing an integral operation on the acceleration data. The OIS control circuit 271 may control the OIS function of the camera module 180 based on the information on the acceleration.

According to an embodiment, the OIS control circuit 271 may acquire angular velocity data from the gyro sensor. The OIS control circuit 271 may acquire information on an angle at which the electronic device 101 shakes by performing an integral operation on the angular velocity data. The OIS control circuit 271 may control the OIS function of the camera module 180 based on the information on the angle.

According to an embodiment, the image signal processor 260 (see FIG. 2) may constantly acquire image frames while the camera module 180 is performing the OIS function. The image signal processor 260 may acquire image frames for which the OIS function is performed from the camera module 180, and may provide the image frames to the AP 290.

According to an embodiment, the AP 290 may acquire image frames for which the OIS function is performed. The AP 290 may perform video digital image stabilization (VDIS) with respect to the image frames for which the OIS function is performed. In another embodiment, the image signal processor 260 may provide image frames for which VDIS is also performed to the AP 290.

According to an embodiment, the camera module 180 may acquire image frames under control of the processor 270. In an embodiment, the camera module 180 may acquire image frames while performing the OIS function by the OIS control circuit 271. In an embodiment, the camera module 180 may provide the image frames acquired while performing the OIS function to the processor 270.

According to an embodiment, the camera module 180 may use a lens shift method to shift a lens assembly 210 (see FIG. 2) through the OIS function. For example, the processor 270 may shift the lens assembly 210 through an actuator 182. The processor 270 may detect a position to which the lens assembly 210 is shifted via the hall sensor (not shown). According to an embodiment, the camera module 180 may use a sensor shift method to shift an image sensor 181 through the OIS function. For example, the processor 270 may shift the image sensor 181 through the actuator 182. The processor 270 may detect a position to which the image sensor 181 is shifted via the hall sensor.

According to an embodiment, the camera module 180 may perform the OIS function within a first range. The first range may be an actuation range of the OIS function and may be a maximum actuation range in which the camera module 180 is allowed to shift the lens assembly 210 to compensate for a motion of the electronic device 101.

According to an embodiment, the camera module 180 may perform the IOS function within a second range that is larger than the first range. The second range may be an extension of the maximum actuation range larger than the first range. The second range may be provided by extending a shift space of the lens assembly 210 at the production step of the camera module 180. For example, if the maximum actuation range of the related-art lens assembly 210 is 1 degree, the maximum actuation range in the disclosure may be set to 3 degrees. However, the above-described numerical values are merely examples. The maximum actuation range of the OIS function may be a fixed value at the time of manufacturing the camera module 180, and may be extended from the first range to the second range or may be reduced from the second range to the first range according to a command of the AP 290.

According to an embodiment, memory 250 (see FIG. 2) may store various programming languages or instructions by the processor 270. For example, the processor 270 may execute an application by executing a code written in a programming language stored in the memory 250, and may control a variety of hardware. In addition, the processor 270 may set and support an appropriate photographing mode to cause the camera module 180 to perform an operation that is intended by a user. In an embodiment, the processor 270 may store image frames for which VDIS is performed in the memory 250. In another embodiment, the processor 270 may store image frames for the OIS function is performed in the memory 250.

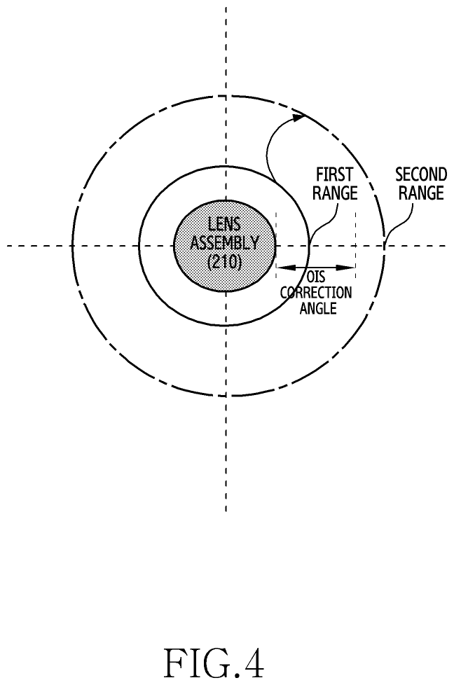

FIG. 4 illustrates an OIS actuation range in which a camera module performs OIS according to an embodiment of the disclosure.

According to an embodiment, a camera module 180 (see FIG. 2) may perform an OIS function within a first range. In an embodiment, a processor 270 (see FIG. 3) may shift a lens assembly 210 (or an image sensor 230) included in the camera module 180 within the first range. For example, an OIS control circuit 271 may rotate the lens assembly 210 within the first range via an actuator 182. The OIS control circuit 271 may detect a position to which the lens assembly 210 is shifted via a hall sensor (not shown).

According to an embodiment, the camera module 180 may perform the OIS function within a second range that is larger than the first range. The camera module 180 may effectively improve jitter even when a large motion occurs in the electronic device 101 as the OIS maximum actuation range is extended. Jitter indicates a phenomenon in which a specific object in a video flickers due to different degrees of blur in respective image frames.

Referring to FIG. 4, the OIS maximum actuation range is an example of the maximum actuation range in which the camera module 180 performs the OIS function. FIG. 4 illustrates the first range and the second range for comparing. The OIS actuation range is an example of the actuation range in which the camera module 180 performs the OIS function. The OIS actuation range may be smaller than or equal to the OIS maximum actuation range. If the OIS maximum actuation range is the second range, the OIS actuation range may be smaller than or equal to the second range.

In the disclosure, it may be understood that the OIS maximum actuation range is the second range. In an embodiment, the processor 270 may perform the OIS function with respect to the OIS actuation range which is included in the OIS maximum actuation range due to physical limitations of the camera module 180.

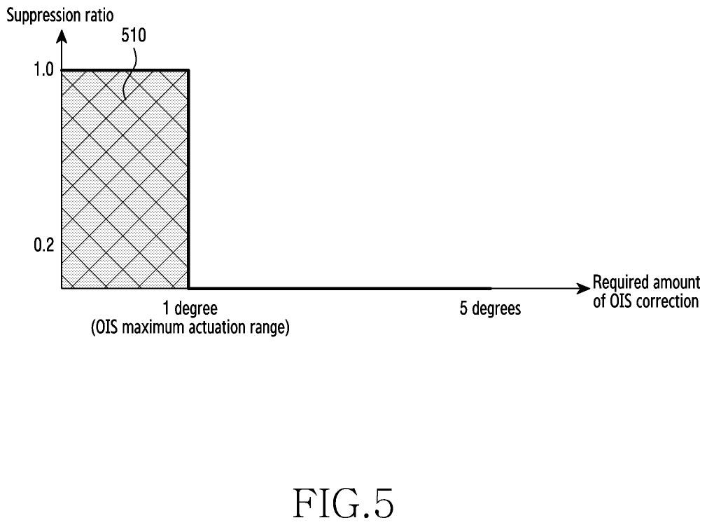

FIG. 5 illustrates an example of determining a suppression ratio by the camera module according to an embodiment of the disclosure.

Referring to FIG. 5, when the motion of the electronic device 101 is relatively small and a required amount of OIS correction is less than or equal to 1 degree (area 510), the processor 270 may improve jitter by shifting the lens assembly 210 (see FIG. 2) within the range of 1 degree. On the other hand, if the motion of the electronic device 101 is relatively large and the required amount of OIS correction exceeds 1 degree, the processor 27 may not execute the OIS function. That is, if a large motion occurs in the electronic device 101 during video recording, the OIS function may be interrupted and a jitter phenomenon may not be improved.

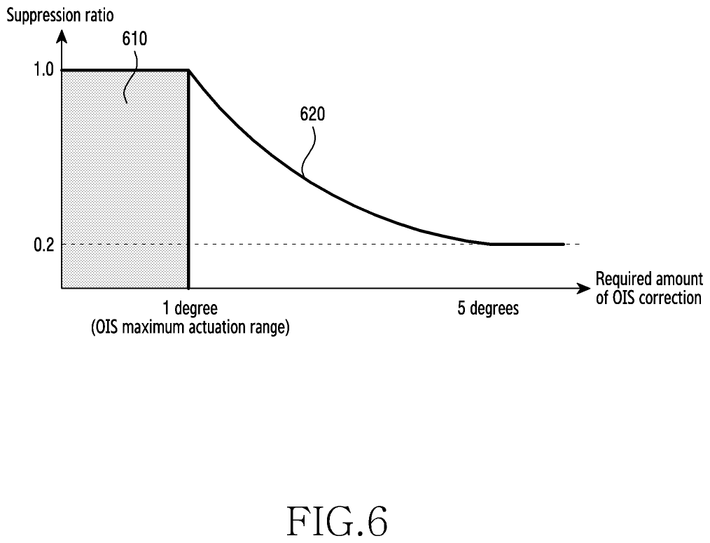

To solve the above-described problem, in an embodiment, a jitter phenomenon may be improved by adjusting a suppression ratio if the motion of the electronic device 101 is relatively large. This will be described in detail with reference to FIG. 6.

FIG. 6 illustrates an example of determining a suppression ratio by the camera module when the required amount of OIS correction exceeds the OIS maximum actuation range according to an embodiment of the disclosure.

Referring to FIG. 6, if the motion of the electronic device 101 is relatively large and the required amount of OIS correction exceeds the OIS maximum actuation range, compared to FIG. 5, the processor 270 may adjust a suppression ratio. Here, the required amount of OIS correction may be determined based on motion data which is acquired from the motion sensor 211. If the required amount of OIS correction is smaller than the OIS maximum actuation range (area 610), the processor 270 may perform the OIS function in the same way as in FIG. 5.

When the motion of the electronic device 101 is relatively large (when the required amount of OIS correction is greater than or equal to 1 degree), the required amount of correction and the suppression ratio may be determined based on the following equation:

$$OIS Maximum Actuation Range = Required Amount of OIS Correction \times Suppression Ratio \qquad Equation 1$$

According to an embodiment, when the required amount of OIS correction is 2 degrees (620), the processor 270 may determine the suppression ratio to be 0.5. In an embodiment, the processor 270 may control the camera module 180 to perform the OIS function within the range of 1 degree, based on the suppression ratio of 0.5. For example, while the electronic device 101 is shaking by 2 degrees, the processor 270 may shift the lens assembly 210 (or the image sensor 230) to perform OIS correction corresponding to 0.5 degree every time the electronic device 101 moves to require an amount of correction corresponding to 1 degree.

According to an embodiment, when the required amount of OIS correction is 5 degrees, the processor 270 may determine the suppression ratio to be 0.2 based on Equation 1. In an embodiment, the processor 270 may control the camera module 180 to perform the OIS function within the range of 1 degree based on the suppression ratio of 0.2. For example, while the electronic device 101 is shaking by 5 degrees, the processor 270 may control the camera module 180 to shift the lens assembly 210 (or the image sensor 230) by 0.2 degree every time the electronic device moves by 1 degree.

According to an embodiment, when the required amount of correction is greater than 5 degrees, the processor 270 may not perform the OIS operation or may restrict the OIS operation based on the suppression ratio of 0.2.

That is, the processor 270 may solve jitter which occurs when the motion of the electronic device 100 is large through an adaptive suppression ratio (ASR).

In the ASR, since the position of the lens assembly 210 (or the image sensor 230) constantly changes every short time, the suppression ratio should be changed every time. If the processor 270 does not provide an appropriate suppression ratio, micro-shaking may occur in an image frame to be provided to VDIS. In addition, if the OIS maximum actuation range is small, the electronic device 101 may have a problem of being vulnerable to jitter when a large motion occurs in the electronic device 101 since the suppression ratio is only 0.2 and the lens assembly 210 moves with the small suppression ratio.

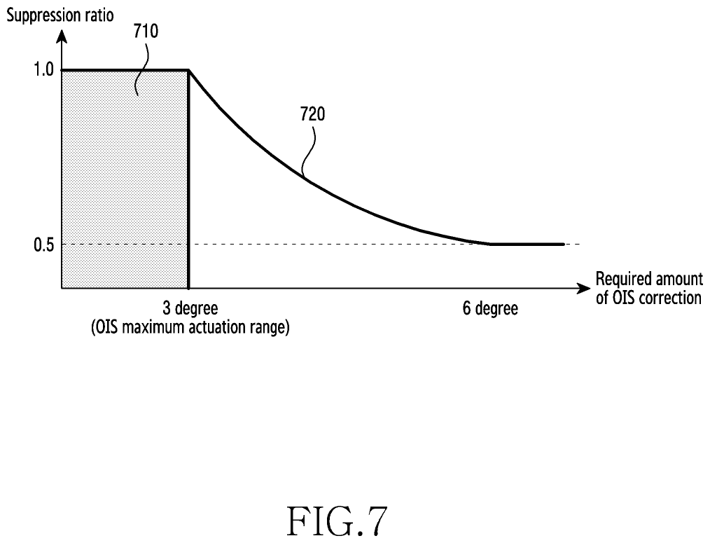

Accordingly, the disclosure may improve jitter even in response to a large motion of the electronic device 101 by increasing a minimum suppression ratio by extending the OIS maximum actuation range. This will be described in detail with reference to FIG. 7.

FIG. 7 illustrates an example of determining a suppression ratio when the OIS maximum actuation range of the camera module is extended according to an embodiment of the disclosure.

Referring to FIG. 7, when the OIS maximum actuation range is 3 degrees, the camera module 180 according to an embodiment may set the suppression ratio to decrease to 0.5 in the section where the required amount of OIS correction is 3 degrees to 6 degrees. When the motion of the electronic device 101 is relatively large and the required amount of OIS correction exceeds 6 degrees, the camera module 180 may not perform the OIS operation or may restrict the OIS operation based on the minimum suppression ratio of 0.5. For a relationship between the required amount of OIS correction and the suppression ratio, reference is made to Equation 1. For the area 720 in which the required amount of OIS correction is above the OIS maximum actuation range, reference is made to embodiments on the area 620 of FIG. 6.

In the disclosure, the OIS maximum actuation range of the camera module 180 is extended so that a blur phenomenon is reduced and jitter is improved, but in the area 710 in which the motion of the electronic device 101 is relatively small, another problem of micro-shaking may occur. This is because when the OIS maximum actuation range is extended, the shift amount of the lens assembly 210 becomes relatively large.

Micro-shaking may occur when the motion of the electronic device 101 is relatively small, and, when the motion is relatively large, jitter may be predominant over micro-shaking. The motion of the electronic device 101 is important to the OIS function, but an exposure time should be considered in addition to the motion of the electronic device 101 to perform effective OIS since the degree of blur varies with the exposure time.

To solve the above-described problem, the disclosure determines a suppression ratio by using an exposure time and motion information of the electronic device, in addition to adjusting the suppression ratio based on a position of OIS.

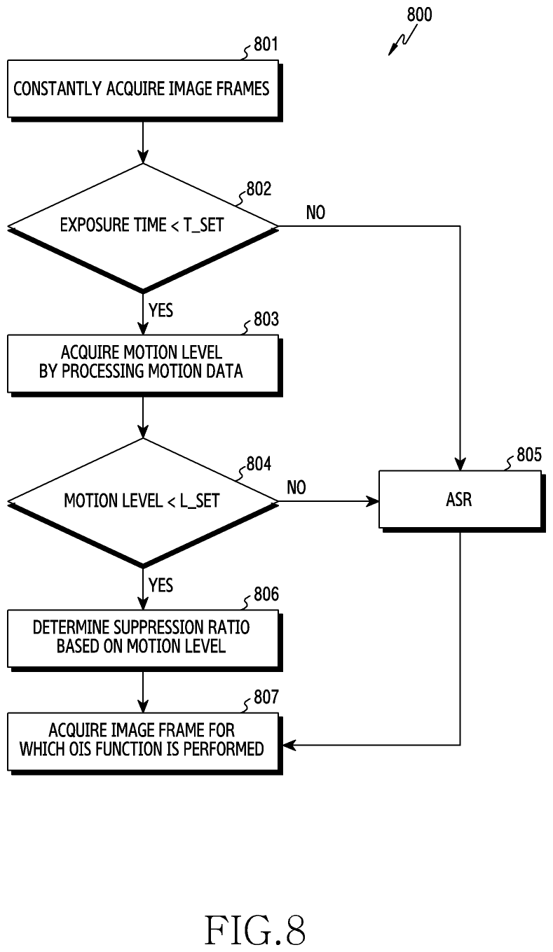

FIG. 8 is a flowchart 800 illustrating an operating method of an electronic device according to an embodiment of the disclosure.

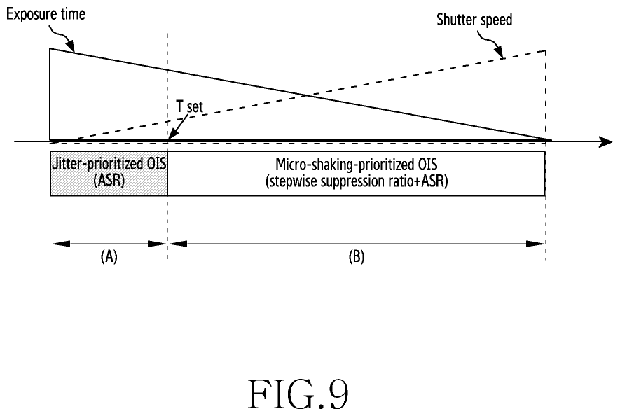

FIG. 9 illustrates a priority between jitter and micro-shaking with the exposure time according to an embodiment of the disclosure.

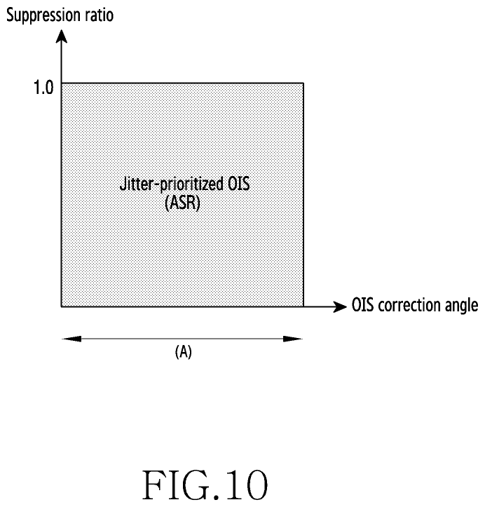

FIG. 10 illustrating an example of determining a suppression ratio when the exposure time is relatively long according to an embodiment of the disclosure.

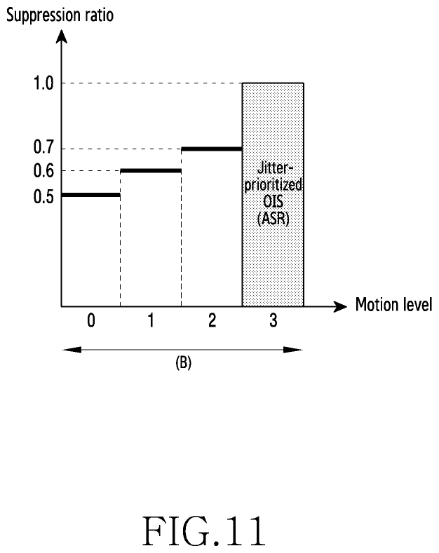

FIG. 11 illustrates an example of determining a suppression ratio when the exposure time is relatively short according to an embodiment of the disclosure. For embodiments according to FIG. 8, reference is made to FIGS. 9 to 11.

The processor 270 may continuously acquire image frames through the camera module 180 at operation 801.

According to an embodiment, the processor 270 may acquire motion data from the motion sensor 211 while continuously acquiring image frames through the camera module 180.

In addition, according to an embodiment, the processor 270 may acquire illuminance data from the illuminance sensor 212 while continuously acquiring image frames through the camera module 180. The processor 270 may process the illuminance data to determine whether the electronic device 101 is in a low-luminance environment or a high-luminance environment.

According to an embodiment, the processor 270 may actuate the camera module 180, and may continuously acquire image frames through the image sensor 181. For example, the processor 270 may take a video through the camera module 180, and may acquire continuous image frames included in video data.

The processor 270 may determine whether to perform OIS by prioritizing jitter or micro-shaking according to the exposure time of the camera module 180. Referring to FIG. 9, jitter-prioritized OIS may be performed when the exposure time is relatively long with reference to a pre-defined exposure time T_set (area A), and micro-shaking-prioritized OIS may be performed when the exposure time is relatively short (area B). The exposure time is a value that is determined according to a shutter speed, and a fast shutter speed means a short exposure time. Accordingly, being based on the exposure time is the same as being based on the shutter speed, and in the disclosure, an OIS process will be described with reference to the exposure time.

According to an embodiment, when the exposure time is less than or equal to the pre-defined exposure time T_set at operation 802, the processor 270 may acquire a motion level by processing motion data at operation 803. When the exposure time is relatively short, it may be predicted that micro-shaking is more predominant than jitter. Accordingly, the processor 270 may determine the degree of motion of the electronic device 101 through the motion level, and may perform the OIS function through a stepwise suppression ratio according to the motion level.

The processor 270 according to an embodiment may determine a motion level corresponding to the motion of the electronic device by processing at least one of acceleration data or angular velocity data. The processor 270 according to an embodiment may determine a suppression ratio based on a motion level received from the AP 290 without directly calculating the motion level.

The processor 270 according to an embodiment may determine an exposure time according to a control command of the AP 290. For example, the exposure time may be determined according to a user input which is set through an application.

In addition, the processor 270 according to an embodiment may determine an exposure time based on illuminance measured via the illuminance sensor 212, and, when the exposure time is less than or equal to the pre-defined exposure time, the processor 270 may acquire a motion level by processing motion data. The processor 270 may set the exposure time to be long in a low-illuminance environment, and may set the exposure time to be short in a high-illuminance environment.

The motion level may be a criterion for the motion of the electronic device which is acquired by processing motion data, and may indicate a result value that is obtained by processing signals generated in an acceleration sensor, a gyro sensor (gyroscope), a magnetic sensor, or a hall sensor.

The motion level may indicate an amount of change in pixels constituting an image when the size of a signal obtained by the motion sensor 211 (which is proportional to the degree of motion of the electronic device) is reflected on the image. Accordingly, the motion level may apply a weighting according to performance information of the camera module 180. The processor 270 according to an embodiment may apply a weighting to the motion level, based on information on a field of view (FOV) of the camera module 180 or information on a resolution of the display module 160.

In an embodiment, the processor 270 may apply a first weighting to the motion level when the FOV of the camera module 180 is smaller than a pre-defined FOV range.

In an embodiment, the processor 270 may apply a second weighting which is larger than the first weighting to the motion level when the FOV of the camera module 180 is larger than the pre-defined FOV range.

In an embodiment, the processor 270 may apply different weightings to the motion level based on the resolution of the display module 180. For example, the processor 270 may apply a relatively small weighting to the motion level as the resolution is higher, and may apply a relatively large weighting to the motion level as the resolution is lower.

On the other hand, when the exposure time is relatively long (the area A of FIGS. 9 and 10), the processor 270 according to an embodiment may omit the process of processing motion data since the motion of the electronic device is relatively less important. When the exposure time is longer than the pre-defined exposure time T_set, the processor 270 according to an embodiment may perform the OIS function through an adaptive suppression ratio (ASR) at operation 805. In this case, in order to preferentially solve jitter rather than micro-shaking, the processor 270 may adaptively adjust the suppression ratio based on a position of a correction angle of the OIS function.

Meanwhile, when the motion level is lower than a pre-defined motion level L_set at operation 804, the processor 270 according to an embodiment may determine a suppression ratio based on the motion level at operation 806. Specifically, when the motion level is lower than the pre-defined motion level, the processor 270 may perform the OIS function based on a suppression ratio which increases stepwise according to the motion level.

For example, referring to FIG. 11, the B area is where the exposure time is relatively short and micro-shaking is predominant over jitter (see FIG. 9), and the processor 270 may adjust the suppression ratio stepwise in the section where the motion level is less than or equal to 2. The electronic device 101 may solve the problem of micro-shaking by adjusting the suppression ratio stepwise. However, when the motion of the electronic device is so large that the motion level is greater than or equal to 3, it is predicted that jitter is predominant again, and the processor 270 according to an embodiment may perform the OIS function through the ASR. However, the suppression ratio at each motion level proposed in FIG. 11 is merely an example for the convenience of explanation, and may be set variously according to data of the camera module 180.

According to an embodiment, the processor 270 may acquire image frames for which the OIS function is performed at operation 807.

According to an embodiment, when the exposure time of the image sensor 181 obtained based on the shutter speed is less than or equal to the pre-defined exposure time while the image frames are being obtained through the camera module 180, the processor 270 may determine a suppression ratio based on the motion level and may acquire image frames for which the OIS function is performed according to the determined suppression ratio. In this case, the processor 270 may determine the suppression ratio of the OIS function based on a table stored in the memory 250. The table according to an embodiment may be data indicating suppression ratios assigned to motion levels.

When the exposure time is less than or equal to the pre-defined exposure time and the motion level is less than or equal to the pre-defined motion level, the processor 270 according to an embodiment may perform the OIS function through a stepwise suppression ratio. The processor 270 may perform the OIS function based on the suppression ratio which increases stepwise according to the motion level.

When the exposure time is longer than the pre-defined exposure time, the processor 270 according to an embodiment may adaptively adjust the suppression ratio based on a correction angle position of the OIS function. That is, the processor 270 may constantly change the suppression ratio according to a predetermined period (for example, a readout timing) based on at least one of the position of the OIS correction angle or the required amount of OIS correction.

When the exposure time is less than or equal to the pre-defined exposure time and the motion level is greater than or equal to the pre-defined value, the processor 270 according to an embodiment may adaptively adjust the suppression ratio based on the position of the OIS correction angle. In the corresponding section, micro-shaking is predominant, but it is effective when jitter is prioritized due to severe motions of the electronic device. Accordingly, the processor 270 according to an embodiment may constantly change the suppression ratio according to a predetermined period (for example, a readout timing) based on at least one of the position of the OIS correction angle or the required amount of OIS correction.

According to an embodiment, the actuation range of the OIS function of the camera module 180 may extend from a first range to a second range. For example, the OIS maximum actuation range of the camera module 180 to which embodiments of the disclosure are applied may be 3 degrees, not 1 degree. The OIS maximum actuation range may be one piece of data that is fixed in the process of manufacturing the camera module 180, but the OIS maximum actuation range may be changed later by setting. For example, the OIS maximum actuation range may be set as the second range by default, but may be reduced from the second range to the first range according to setting. When the OIS maximum actuation range of the camera module 180 is the second range, the OIS maximum actuation range may change from the first range to the second range or from the second range to the first range according to a control command of the AP 290.

When the actuation range of the OIS function is extended from the first range to the second range, the processor 270 according to an embodiment may acquire the motion level by processing the motion data.

In the above, a motion correction method for solving jitter or micro-shaking in the OIS process as the OIS maximum actuation range is extended has been described. The electronic device 101 may correct shaking of a predetermined level or more through VDIS in addition to the OIS function for correcting shaking.

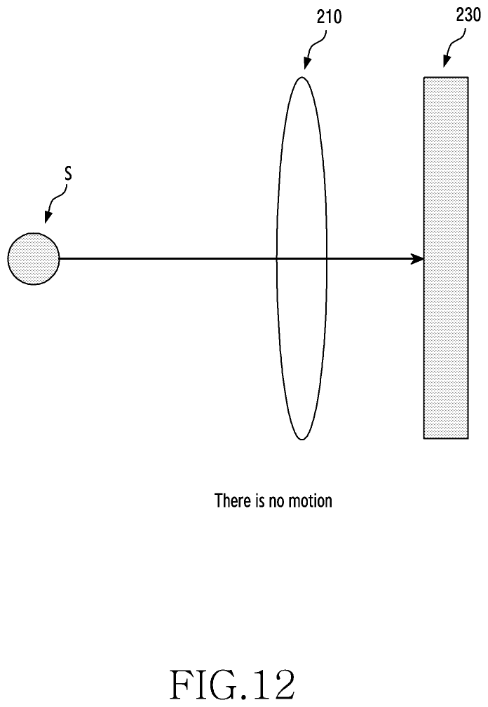

Meanwhile, the extension of the OIS maximum actuation range may additionally cause a problem on perspective distortion in the VDIS process. This will be described with reference to FIGS. 12 to 14.

FIG. 12 illustrates an OIS operation when there is no motion of the electronic device according to an embodiment of the disclosure.

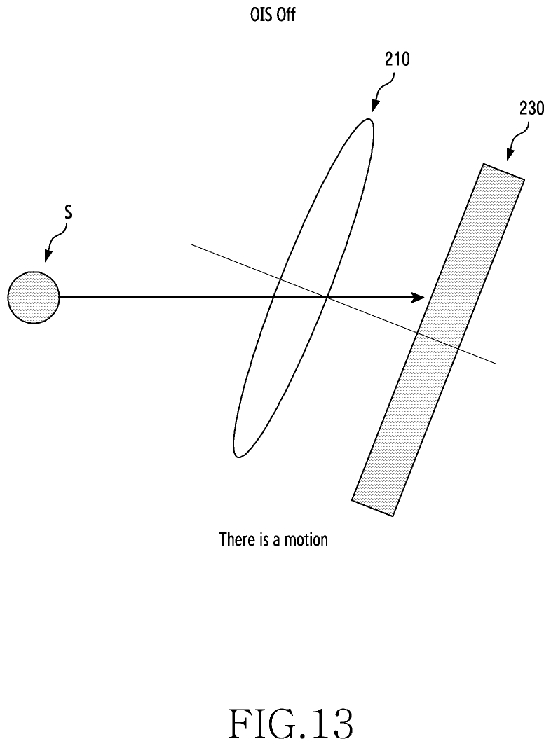

FIG. 13 illustrates a state in which the OIS function is turned off when there is a motion of the electronic device according to an embodiment of the disclosure.

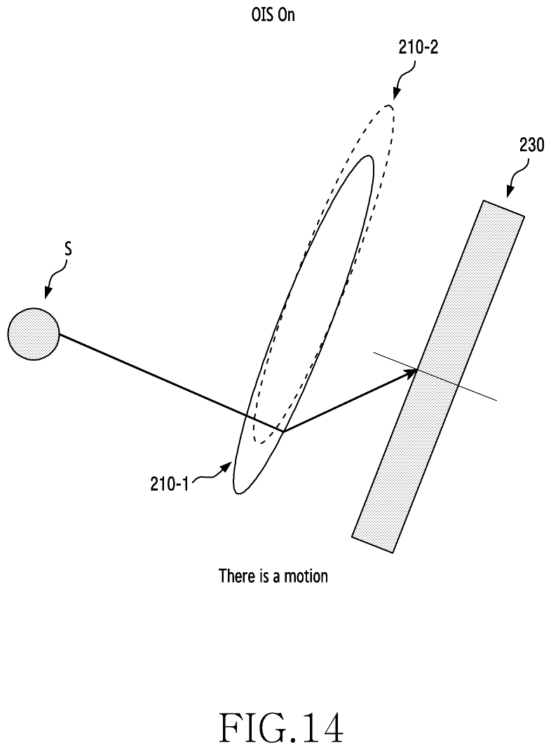

FIG. 14 illustrates a state in which the OIS function is turned on when there is a motion of the electronic device according to an embodiment of the disclosure.

Referring to FIG. 12, when there is no motion of the electronic device, light reflected from an object S may pass through the lens assembly 210 and may be collected at the center of the image sensor 230 which is a right position.

On the other hand, referring to FIG. 13, when there is a motion of the electronic device in the state where the OIS function is turned off, light reflected from an object S may be collected out of the center of the image sensor 230 since a surface incident angle on the lens assembly 210 is changed.

Referring to FIG. 14, in the state where the OIS function is turned on, the lens assembly 210 is shifted relative to the image sensor 230, thereby allowing the light reflected from the object S to be collected at the center of the image sensor 230. As described above, the OIS maximum actuation range may be extended from a first range 210-1 to a second range 210-2. As the OIS maximum actuation range is extended and a moving distance of the lens assembly 210 increases, more severe perspective distortion may occur in image frames. Perspective distortion is a phenomenon in which an object or surroundings of the object are distorted or deformed within an image frame, and may occur as a focal distance varies according to an angle of incident rays. Perspective distortion may occur by OIS wobbling.

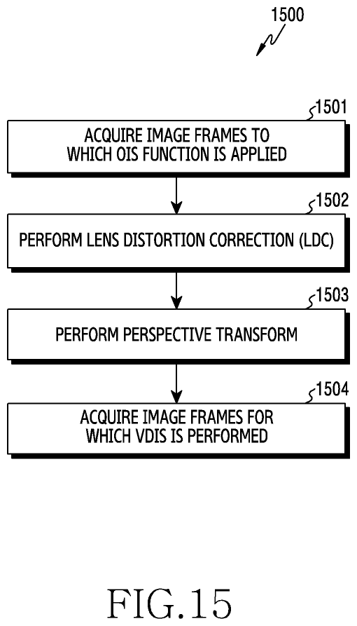

FIG. 15 is a flowchart 1500 of an operating method of the electronic device according to an embodiment of the disclosure.

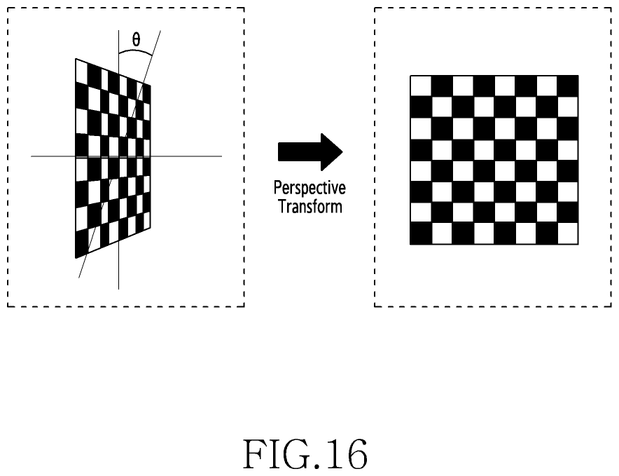

FIG. 16 illustrates an example of perspective transform according to an embodiment of the disclosure.

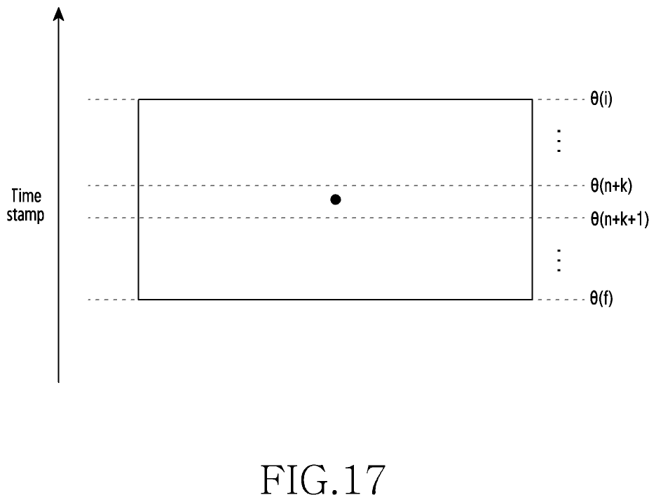

FIG. 17 illustrates an example of a process of deriving an OIS angle for perspective transform in FIG. 16 according to an embodiment of the disclosure. FIG. 15 will be described with reference to FIGS. 16 and 17.

The processor 270 according to an embodiment may acquire image frames to which an OIS function is applied at operation 1501. The camera module 180 may acquire image frames under control of the processor 270. In an embodiment, the camera module 180 may acquire image frames while performing the OIS function through the OIS control circuit 271. In an embodiment, the camera module 180 may provide the image frames which are obtained while performing the OIS function to the processor 270. The processor 270 may control an OIS module (actuator 182) to shift the lens module (lens assembly 210) while performing the OIS function. Here, the OIS maximum actuation range of the OIS actuation module may be an extension from the first range to the second range. The processor 270 may acquire an OIS correction angel of a position to which the lens module is shifted.

The processor 270 according to an embodiment may perform lens distortion correction (LDC) at operation 1502 and then may perform perspective transform at operation 1503. That is, the processor 270 may perform LDC first before perspective transform.

The processor 270 according to an embodiment may acquire the OIS correction angle of the position to which the lens module is shifted to perform perspective transform. The processor 270 may calculate a transform angle (0) (see FIG. 16) for perspective transform based on the acquired OIS correction angle. The relationship between the OIS correction angle and the transform angle may be defined based on various mathematical techniques, and the transform angle may be derived from a neural network model which has OIS correction angles as input data and has transform angles as output data by using various algorithms of machine learning.

The processor 270 may acquire a plurality of OIS correction angles with different values according to a readout timing while generating one image frame. For example, referring to FIG. 17, the processor 270 may acquire the plurality of OIS correction angles (θ(i) to θ(n+k), θ(n+k+1) to θ(f)) every time data is read out. According to an embodiment, the processor 270 may acquire an OIS correction angle at intervals of 1 KHz. In this case, the OIS correction angle transmitted within one image frame may have different values while the OIS function is being performed. The processor 270 according to an embodiment may acquire the OIS correction angle at regular intervals while acquiring the image frames. The processor 270 may determine a transform angle based on an average between a first correction angle that is closest to the center within the image frame, and a second correction angle obtained after the second correction angle. That is, interpolation may be used to estimate an OIS correction angle at the center of the image frame.

The processor 270 according to an embodiment may acquire image frames for which VDIS is performed at operation 1504. The processor 270 according to an embodiment may perform VDIS with respect to the image frame in which perspective distortion occurs, based on the transform angle.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a motion sensor configured to output a signal for acquiring motion data corresponding to a motion of the electronic device;
a camera module comprising an image sensor and an optical image stabilization (OIS) module which is configured to perform OIS based on the motion of the electronic device;
memory storing one or more computer programs; and
one or more processors communicatively coupled to the motion sensor, the camera module, and the memory,
wherein the one or more computer programs include computer-executable instructions that, when executed by the one or more processors individually or collectively, cause the electronic device to:
determine motion state information based on a size of the motion data when an exposure time of the image sensor is less than or equal to a pre-defined exposure time while image frames are constantly acquired through the camera module,
determine a suppression ratio related to an actuation range of the OIS module, based on the motion state information, and
control an operation of the OIS module based on the determined suppression ratio.

2. The electronic device of claim 1,
wherein the motion state information comprises a motion level based on which the size of the motion data is divided stepwise,
wherein the memory is configured to store a table in which suppression ratios are assigned by motion levels, and
wherein the instructions, when executed by the one or more processors individually or collectively, further cause the electronic device to determine a suppression ratio on the OIS module based on the stored table.

3. The electronic device of claim 1, wherein the instructions, when executed by the one or more processors individually or collectively, further cause the electronic device to adaptively adjust the suppression ratio based on a correction angle position of the OIS module when the exposure time is longer than the pre-defined exposure time.

4. The electronic device of claim 2, wherein the instructions, when executed by the one or more processors individually or collectively, further cause the electronic device to adaptively adjust the suppression ratio based on a correction angle position of the OIS module when the exposure time is less than or equal to the pre-defined exposure time and the motion level is greater than or equal to a pre-defined value.

5. The electronic device of claim 2, wherein the instructions, when executed by the one or more processors individually or collectively, further cause the electronic device to adaptively adjust the suppression ratio based on a required amount of correction angle for the OIS module when the exposure time is less than or equal to the pre-defined exposure time and the motion level is greater than or equal to a pre-defined value.

6. The electronic device of claim 2, wherein the camera module has the actuation range of the OIS module extended from a first range to a second range.

7. The electronic device of claim 6, wherein the instructions, when executed by the one or more processors individually or collectively, further cause the electronic device to acquire the motion level by processing the motion data, based on the actuation range of the OIS module which is extended from the first range to the second range.

8. The electronic device of claim 2, wherein the instructions, when executed by the one or more processors individually or collectively, further cause the electronic device to control the OIS module, based on the suppression ratio which increases stepwise according to the motion level.

9. The electronic device of claim 1,
wherein the motion sensor comprises at least one of an acceleration sensor which outputs a signal for acquiring acceleration data or a gyro sensor which outputs a signal for acquiring angular velocity data, and
wherein the instructions, when executed by the one or more processors individually or collectively, further cause the electronic device to determine a motion level corresponding to the motion of the electronic device, based on at least one of the acceleration data or the angular velocity data.

10. The electronic device of claim 2, further comprising:
an illuminance sensor configured to output a signal for measuring ambient illuminance of the electronic device,
wherein the instructions, when executed by the one or more processors individually or collectively, further cause the electronic device to:
determine the exposure time based on the measured illuminance, and
acquire the motion level by processing the motion data when the exposure time is less than or equal to the pre-defined exposure time.

11. An operating method of an electronic device, the operating method comprising:
constantly acquiring image frames through a camera module;
acquiring motion data corresponding to a motion of the electronic device;
determining motion state information based on a size of the motion data when an exposure time of an image sensor is less than or equal to a pre-defined exposure time while the image frames are constantly acquired;
determining a suppression ratio related to an actuation range of an optical image stabilization (OIS) module, based on the motion state information; and
controlling an operation of the OIS module based on the determined suppression ratio.

12. The operating method of claim 11,
wherein determining the motion state information based on the size of the motion data comprises determining a suppression ratio on the OIS module based on a table in which suppression ratios are assigned by motion levels, and
wherein the motion state information comprises a motion level based on which the size of the motion data is divided stepwise.

13. The operating method of claim 11, further comprising:
adaptively adjusting the suppression ratio based on a correction angle position of the OIS module when the exposure time is longer than the pre-defined exposure time.

14. The operating method of claim 11, further comprising:
adaptively adjusting the suppression ratio based on a correction angle position of the OIS module when the exposure time is less than or equal to the pre-defined exposure time and the motion level is greater than or equal to a pre-defined value.

15. The operating method of claim 11, further comprising:
adaptively adjusting the suppression ratio based on a required amount of correction angle for the OIS module when the exposure time is less than or equal to the pre-defined exposure time and the motion level is greater than or equal to a pre-defined value.

16. The electronic device of claim 12, wherein the acquiring of the motion level by processing the motion data comprises, when the actuation range of the OIS module is extended from a first range to a second range, acquiring the motion level by processing the motion data.

17. An electronic device comprising:
a motion sensor configured to output a signal for acquiring motion data corresponding to a motion of the electronic device;
a camera module comprising a lens module and configured to perform an OIS function;
an OIS actuation module configured to shift the lens module within an actuation range of the OIS function; and
at least one processor; and
memory storing instructions that, when executed by the at least one processor, cause the electronic device to:
control the OIS actuation module to shift the lens module when a motion of the electronic device occurs while image frames are constantly acquired through the camera module;
acquire a correction angle of the OIS function at a position to which the lens module is shifted;
determine a transform angle for perspective transform of the image frame based on the correction angle; and
perform video digital image stabilization (VDIS) based on the transform angle.

18. The electronic device of claim 17, wherein the OIS actuation module is configured to shift the lens module according to a second range of the actuation range of the OIS function which is larger than a first range.

19. The electronic device of claim 17, wherein the instructions, when executed by the at least one processor, further cause the electronic device to acquire a correction angle at regular intervals while acquiring the image frame, and the correction angle comprises a first correction angle and a second correction angle that is acquired after the first correction angle, and
wherein the at least one processor is configured to determine the transform angle based on an average between the first correction angle and the second correction angle.

20. The electronic device of claim 17, wherein the instructions, when executed by the at least one processor, further cause the electronic device to perform lens distortion correction (LDC) before transforming the image frame based on the transform angle.
